(19) United States
(12) Patent Application Publication
(10) Pub. No.: US 2010/0110245 A1
(43) Pub. Date: May 6, 2010

(54) SOLID-STATE IMAGING DEVICE

(75) Inventors: Takumi Yamaguchi, Kyoto-shi (JP); Takahiro Iwasawa, Kyoto-shi (JP)

Correspondence Address: MOTS LAW, PLLC, 1629 K STREET N.W., SUITE 602, WASHINGTON, DC, 20006-1635, US

(73) Assignee: ROSNES CORPORATION, Kyoto-shi (JP)

(21) Appl. No.: 12/595,201

(22) PCT Filed: Apr. 16, 2008
(86) PCT No.: PCT/JP2008/057438

§ 371 Date: Oct. 8, 2009

(30) Foreign Application Priority Data
Apr. 18, 2007 (JP) 2007-108844

(51) Int. Cl. H04N 5/335

(52) U.S. Cl. 348/279; 348/280; 348/E05.091; 348/308

(57) ABSTRACT

A solid-state imaging device according to the present invention comprises: a region (hereinafter, referred to as a pixel cell 100) in which at least a photodiode 101 for performing photoelectric conversion, a readout MOS transistor 102 for reading out from the photodiode 101 an electric charge photoelectrically converted, and a floating diffusion 103 for reading out and storing the electric charge via the readout MOS transistor 102 from the photodiode are arranged; and a region (hereinafter, referred to as a transistor cell 106) which includes an amplifier MOS transistor 105 having a plurality of two or more said pixel cells 100 connected thereto and a reset MOS transistor 104 for resetting a potential of the floating diffusion 103 so as to be a potential the same as a potential of a power source and in which at least the reset MOS transistor 104 and the amplifier MOS transistors 105 are arranged, and the pixel cell 100 and the transistor cell 106 are two-dimensionally arranged.

### TECHNICAL FIELD

The present invention relates to a solid-state imaging device and in particular, to a MOS-type solid-state imaging device which has transistor cells in order to realize miniaturization of pixel cells.

### BACKGROUND ART

In recent years, a MOS-type solid-state imaging device, which is typified by a CMOS image sensor, has features of a low voltage and a low power consumption and is applied in a wide range of fields, for example, in a mobile telephone with a built-in camera and in a digital still camera.

Conventionally, as a MOS-type solid-state imaging device whose pixels each have an amplifying function, a MOS-type solid-state imaging device shown in FIG. 7 and FIG. 8 is widely known. In general, in pursuit of miniaturization of the pixel cells, three transistors are formed in one pixel cell.

FIG. 7 is a configuration diagram of a pixel cell in which three transistors are formed per one pixel. FIG. 8 is a block diagram of a solid-state imaging device in which pixel cells, each of which is shown in FIG. 7, are two-dimensionally arranged.

Here, each of the pixel cells comprises a photodiode, a readout MOS transistor, an amplifier MOS transistor, and a reset MOS transistor. Since in this configuration, the number of transistors needed is small and a full charge-transfer operation can be performed, this configuration is suited for a reduction in a voltage and downsizing.

In addition, in order to enhance image quality, an S/N ratio of a signal read out from the photodiode is heightened. In each of the pixel cells in this MOS solid-state imaging device, a buried photodiode is employed, thereby reducing a dark current and the full charge-transfer operation is performed, thereby enhancing a sensitivity.

In addition, in a signal processing block, owing to a CDS operation using a signal memory and a noise memory provided in each column, removal of an FPN noise and a kTC noise is enabled.

By employing this configuration, a MOS solid-state imaging device with a high sensitivity and a low noise can be obtained and a digital still camera having features which are superior in image quality to those of a digital still camera using a CCD has come to be realized.

Furthermore, in concert with a growth in the number of pixels of the digital still camera, an area per pixel has been decreased and a miniaturization technology has become indispensable. As disclosed in Patent Document 1 in details, in terms of circuit design, an opening area of a photodiode can be widened by employing a configuration in which four pixels share a pixel select transistor and an amplifier MOS transistor.

Patent Document 1: Japanese Patent Application Laid-Open Publication No. 2005-198001

### DISCLOSURE OF THE INVENTION

### Problems to be Solved by the Invention

As described above, in order to carry out imaging, which achieves a high S/N ratio, by using the conventional solid-state imaging device, three MOS transistors per pixel are required, thereby leading to a great difficulty in further miniaturization of the pixel cells. Although owing to advances in a miniaturization technology of a semiconductor manufacturing process, a decrease in each pixel size in the MOS solid-state imaging device is enabled to some extent, problems such as a reduction in a dynamic range due to a reduced power supply voltage and an increase in a 1/f noise due to miniaturization of the amplifier MOS transistor still remain.

Accordingly, as one means which realizes a high dynamic range and a high S/N ratio, in the conventional solid-state imaging device, four readout MOS transistors are connected to one floating diffusion, and an amplifier MOS transistor and a reset MOS transistor are shared, thereby devising a reduction in the number of transistors per pixel.

However, when owing to the miniaturization of the pixel cells, the number of the pixels of a digital still camera or the like is remarkably increased, there arises a problem that a region in which the transistors are formed cannot be secured even with the configuration in which the four pixels share the one floating diffusion, the reset MOS transistor, and the amplifier MOS transistor.

Moreover, there also arises a problem that contacts for connecting to the ground in order to stabilize each P well potential in the semiconductor cannot be arranged.

### Solution to the Problems

A first solid-state imaging device according to the present invention comprises: a region (hereinafter, referred to as a pixel cell) in which at least a photodiode for performing photoelectric conversion, a readout MOS transistor for reading out from the photodiode an electric charge photoelectrically converted, and a floating diffusion for reading out and storing the electric charge via the readout MOS transistor from the photodiode are arranged; and a region (hereinafter, referred to as a transistor cell) which includes an amplifier MOS transistor having a plurality of two or more said pixel cells connected thereto and a reset MOS transistor for resetting a potential of the floating diffusion so as to be a potential the same as a potential of a power source and in which at least the reset MOS transistor and the amplifier MOS transistors are arranged, and the pixel cell and the transistor cell are two-dimensionally arranged.

In a second solid-state imaging device according to the present invention, a transistor cell comprises a well contact for connecting to a GND potential in order to stabilize a potential of a well.

In a third solid-state imaging device according to the present invention, a color signal corresponding to a position of each transistor cell is generated through interpolation based on color information of surrounding pixel cells.

In a fourth solid-state imaging device according to the present invention, a part of a region in each transistor cell is light-shielded by a metal wiring layer of each transistor cell.

### EFFECT OF THE INVENTION

In the first solid-state imaging device according to the present invention, since the number of transistors per pixel cell can be decreased, further miniaturization of a MOS solid-state imaging device and a further increase in the number of pixels are enabled.

In the second solid-state imaging device according to the present invention, a fluctuation in the potential of the well can be stabilized in an early stage. Thus, since well noises occurring at low frequencies can be reduced, a fine image can be obtained.

In the third solid-state imaging device according to the present invention, by conducting the arrangement such that the transistor cells are replaced with the pixel cells, the color signal can be generated through interpolating the color signals based on the information of the color signals of the neighboring pixel cells even though the color signal in response to the photoelectric conversion is not generated in the region of the transistor cell. As a result, since also in the camera signal processing performed downstream, the camera signal processing can be performed without changing the conventional signal processing method, a fine image can be obtained.

In the fourth solid-state imaging device according to the present invention, since further by performing the light shielding using the metal wiring layer of the transistor cell, generation of electrons, which is attributed to light, in the reset MOS transistor, the amplifier MOS transistor, and the floating diffusion can be suppressed, a fine image can be obtained.

As described above, the solid-state imaging device according to the present invention is capable of sufficiently tackling the miniaturization of the MOS-type solid-state imaging device, which has been promoted by a technology of the miniaturization in a semiconductor manufacturing process. Accordingly, since not only the solid-state imaging device which has a small size as well as a large number of pixels can be provided but also noises can be suppressed, a fine image can be obtained.

In addition, the solid-state imaging device according to the present invention is capable of enhancing quality of a shot image of a video camera, a digital still camera, a mobile terminal device, a mobile telephone with a built-in camera, etc.

Moreover, since the solid-state imaging device according to the present invention concurrently realizes downsizing, a cost reduction, and a low power consumption of an imaging device, an optimum solid-state imaging device applicable particularly to a small-sized digital still camera, a mobile telephone with a built-in camera, or the like can be realized.

### BRIEF DESCRIPTION OF THE DRAWINGS

FIG. 1 is a configuration diagram illustrating a pixel cell of a first embodiment according to the present invention.

FIG. 2 is a timing chart of driving the pixel cell of the first embodiment according to the present invention.

FIG. 3 is a plan view of the pixel cell of the first embodiment according to the present invention.

FIG. 4 is a block diagram of an imaging device of the first embodiment according to the present invention.

FIG. 5 is a configuration diagram of a transistor cell of a second embodiment according to the present invention.

FIG. 6 is a diagram showing a layout of color filters of a solid-state imaging device of a third embodiment according to the present invention.

FIG. 7 is a configuration diagram of a conventional pixel cell.

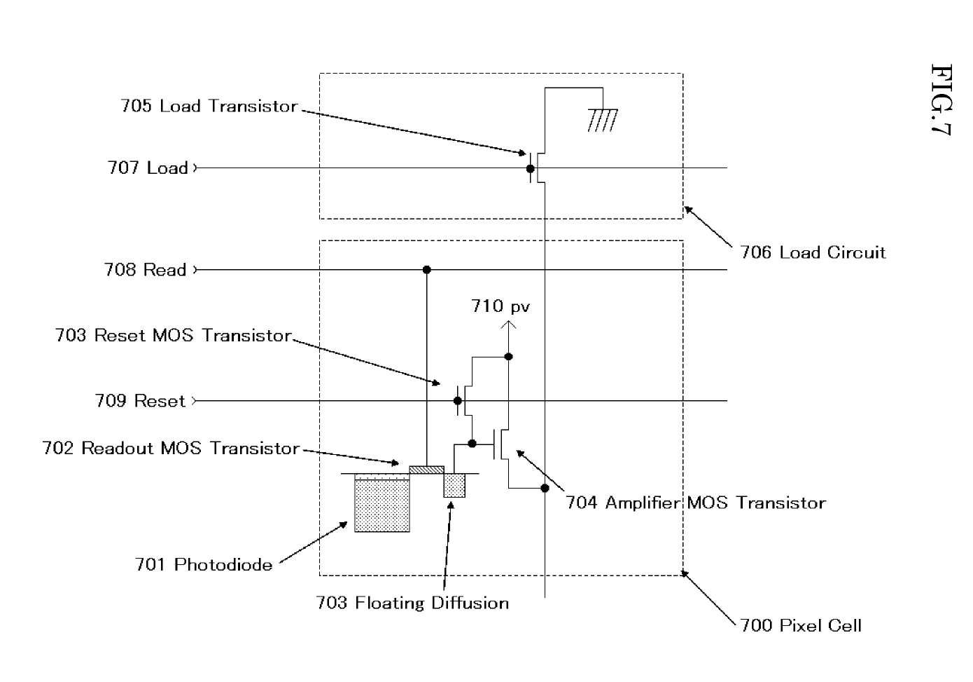

FIG. 8 is a block diagram of a conventional imaging device.

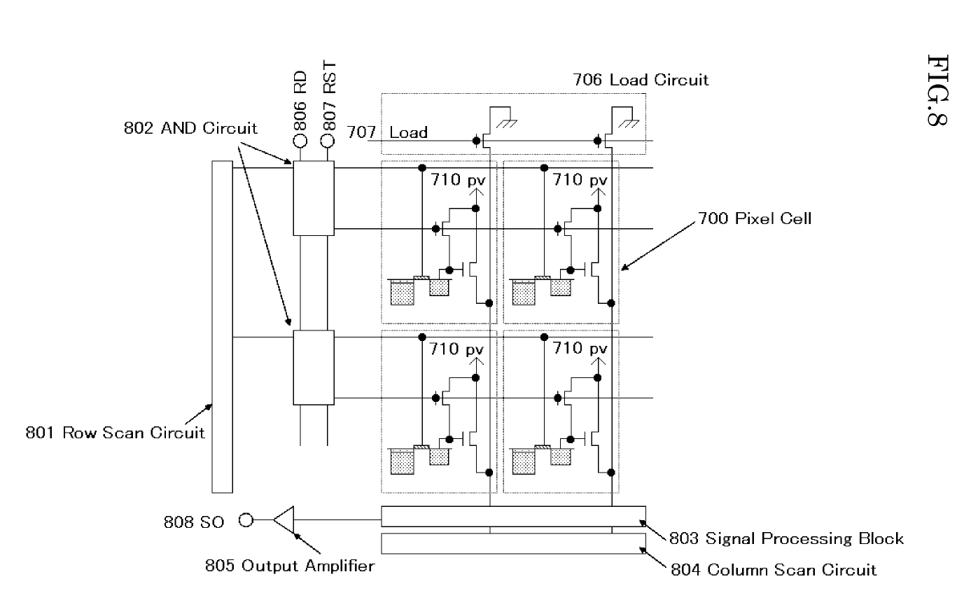

### BEST MODE FOR CARRYING OUT THE INVENTION

In order to realize miniaturization of pixel cells, a MOS-type solid-state imaging device having transistor cells is provided. Hereinafter, an embodiment of the present invention will be described with reference to accompanying drawings.

### First Embodiment

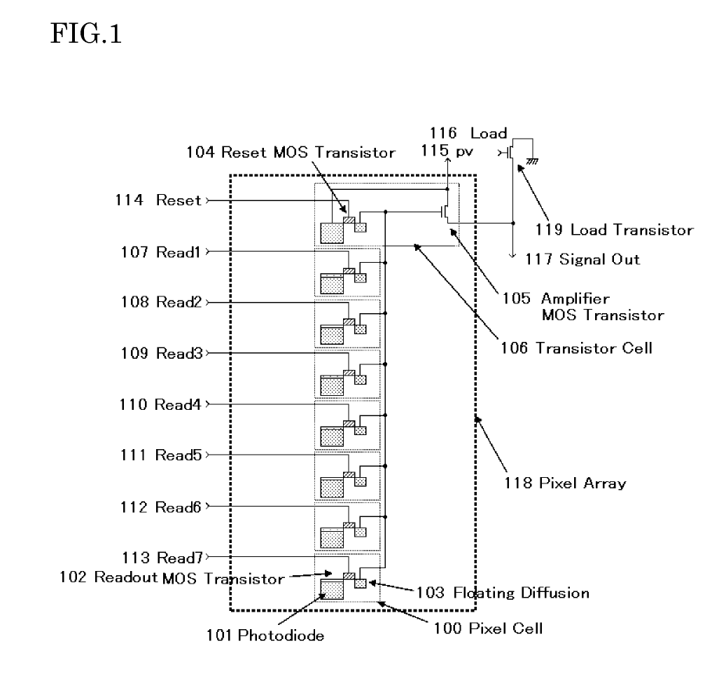

FIG. 1 best shows features of a first embodiment and is a schematic diagram illustrating a circuit configuration of a pixel cell and a sectional view thereof as well as a circuit configuration of a transistor cell and a sectional view thereof.

Each pixel cell 100 comprises a photodiode 101, a readout MOS transistor 102, and a floating diffusion 103. Here, in FIG. 1, a view of the pixel cell is shown as a sectional view of a silicon substrate and a view of the circuit is shown as a circuit configuration diagram illustrating the transistor. Although in FIG. 1, the floating diffusion 103 is arranged in the pixel cell in a corresponding manner, the floating diffusion 103 may be arranged in the transistor cell in a corresponding manner, instead of the each individual pixel cell. In addition, even if the floating diffusion 103 is arranged so as to be divided for, and disposed in, each of the pixel cells sharing the floating diffusion 103, the substantially same effect as that of the present invention can be attained.

Readout pulses 107 through 113 are connected to the pixel cells 100, respectively. In addition, the floating diffusion 103 is shared by connecting wires between couples of the pixel cells.

The transistor cell 106 comprises a reset MOS transistor 104 and an amplifier MOS transistor 105, and the floating diffusion 103 shared by the pixel cells is connected to the reset MOS transistor 104 and the amplifier MOS transistor 105.

The amplifier MOS transistor 105 shares a load transistor 119 and a Signal out 117. A structure in which a plurality of the pixel cells 100 and one transistor cell 106 are arranged is referred to as a pixel array 118.

The load transistor 119 is DC-biased by a bias voltage load 116 and operates so as to exert a constant load. A signal read out from each of the pixel cells is outputted as a Signal out 117 to a column readout line and transmitted to a signal processing block 403.

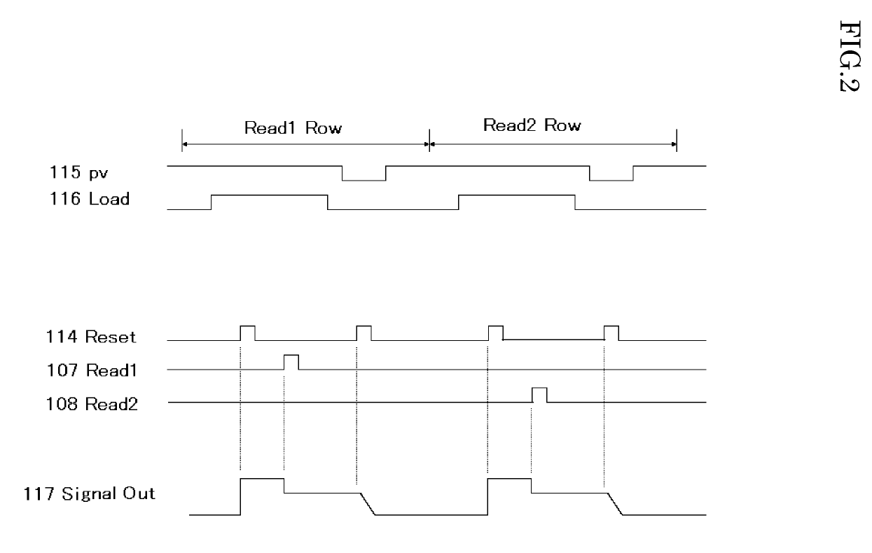

Next, a method of driving the solid-state imaging device of the first embodiment will be described with reference to a timing chart shown in FIG. 2. FIG. 2 is the timing chart for operating the pixel cell 100 and transistor cell 106 shown in FIG. 1.

First, an operation of the pixel cell 100, performed when a read1 row is selected, will be described in detail. In particular, the operation of the pixel cell 100, performed when the read1 row is selected and an operation of the pixel cell 100, performed when a read2 row is selected, will be described. The following paragraphs (1) through (5) describe chronological changes in the operations of the pixel cell 100, performed when the read1 row and the read2 row are selected.

(1) When the pixel cell 100 in the read1 row is selected, a reset pulse (reset 114) applied to the pixel cell 100 in the read1 row comes to have a Hi potential in order to make a potential of the floating diffusion 103 the same as a Hi potential of a power source section (pv 115), thereby setting the reset MOS transistor 104 in a ON state. This causes the potential of the floating diffusion 103 to be the same as the Hi potential of the power source section (pv 115) and the potential in accordance with the above-mentioned Hi potential is outputted from the amplifier MOS transistor 105, thereby resulting in a rise in a potential of an output signal line (Signal out 117).

(2) The reset pulse (reset 114) comes to have a Lo potential, thereby setting the reset MOS transistor 104 in an OFF state. At this time, the floating diffusion 103 maintains the Hi potential.

(3) A read pulse (read1 107) comes to have a Hi potential, thereby setting the readout MOS transistor 102 in an ON state. This causes electric charges accumulated in the photodiode 101 in accordance with optical information to be read out by the floating diffusion 103, thereby resulting in a decline in the potential of the floating diffusion 103. In accordance with the decline in the potential of the floating diffusion 103, a potential of an output section of the amplifier MOS transistor 105 declines and a potential of an output signal line (Signal out 117) declines.

(4) A read pulse (read1 107) comes to have a Lo potential, thereby setting the readout MOS transistor 102 in an OFF state. A potential difference of the output signal line (Signal out 117) is measured as a pixel signal. Thereafter, the power source section (pv 115) comes to have a Lo potential.

(5) In order to make the potential of the floating diffusion 103 the same as the Lo potential of the power source section (pv 115), the potential of the reset pulse (reset 114) comes to have a Hi potential, thereby setting the reset MOS transistor 104 in an ON. This causes the potential of the floating diffusion 103 to be a Lo potential, thereby setting the amplifier MOS transistor 105 in an OFF state.

As described above, the operation of outputting the pixel signal of the pixel cell 100 arranged in the read1 row is finished. Similarly, when the read2 row is selected, the above-described operations (1) through (5) are performed. In this case, the readout pulse for operating the readout MOS transistor is replaced with the readout pulse (read 108). A pixel signal is eventually outputted to the output signal line (Signal out 117).

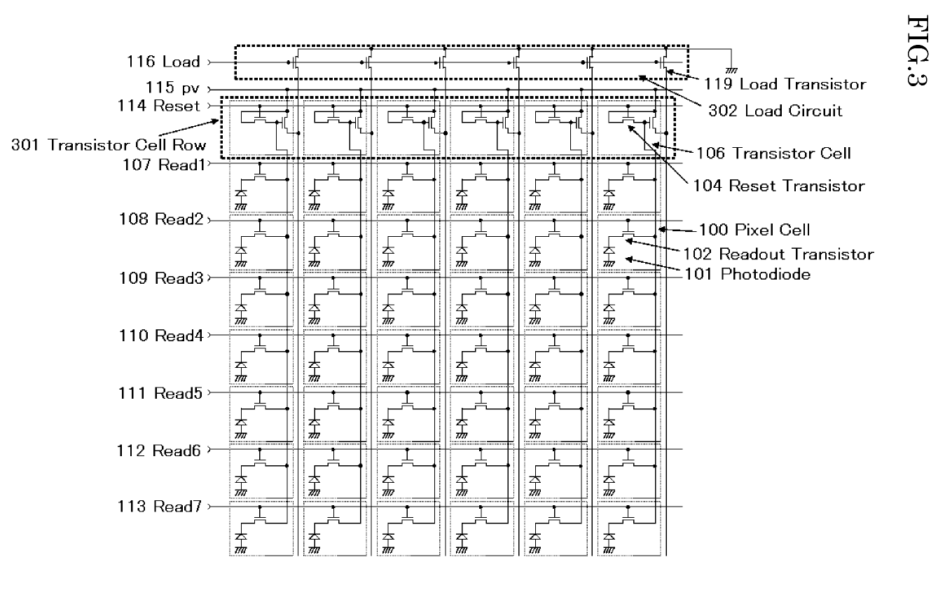

FIG. 3 is a diagram illustrating a plan view of the solid-state imaging device of the first embodiment, in which the pixel arrays 118, each of which is shown FIG. 1, are two-dimensionally arranged. With reference to FIG. 3, an arrangement of the transistor cells 106 will be described.

In the present embodiment, a plurality of pixel cells share one transistor cell 106. When the arrangement on a silicon substrate is conducted, each of the transistor cells 106 is arranged in the same region of each of the pixel cells, and vertical and horizontal wires sharing the readout pulse, the reset pulse, and the readout signal line are formed by metal wiring layers.

As shown in FIG. 3, the plurality of transistor cells 106 are arranged in a row direction, thereby forming a transistor cell row 301. As a result, one transistor cell 106 shares seven pixel cells in a column direction. In FIG. 3, the transistor cells 106 are arranged in the single row direction in order to facilitate understanding of the description. However, the present embodiment is not limited thereto. The transistor cells 106 may be arranged in any position.

In the case where the transistor cells 106 are arranged in any position, a reset pulse wire is arranged in the wire in the row direction in which the transistor cells 106 are present. In addition, because the output signal line is shared in each column, a signal can be read out by providing one load transistor 119 in one column. As shown in FIG. 3, a condition in which the load transistor 119 is arranged in the row direction is referred to as a load circuit 302.

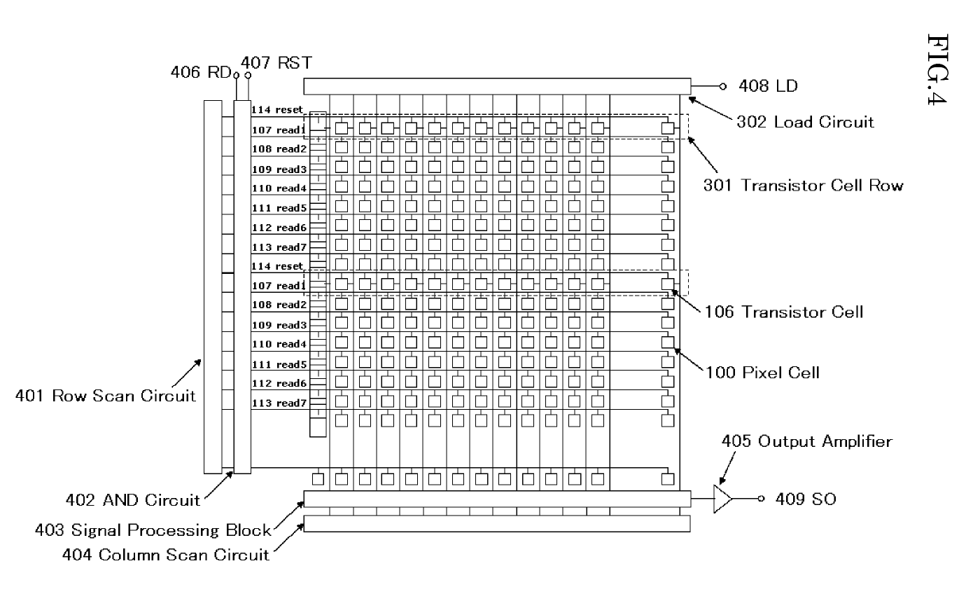

FIG. 4 is a block diagram illustrating a view in which the plan view of the solid-state imaging device of the first embodiment shown in FIG. 3 is further enlarged, with peripheral circuitry also illustrated. A row scan circuit 401 generates a pulse for selecting the two-dimensionally arranged pixel cells and transistor cells 106 on a row-to-row basis.

An AND circuit 402 is to obtain logical multiplication results of a readout pulse (RD 406), a reset pulse (RST 407), and a row select signal. A column scan circuit 404 is to generate a pulse for sequentially selecting each column A signal processing block 403 is a circuit for performing column signal processing of the MOS solid-state imaging device and includes a noise cancel circuit, an ADC, a signal arithmetic circuit, and the like. The circuits included in the signal processing block 403 can be changed in accordance with features of a product. However, even if the kinds of the circuits therein are changed, the effect of the present invention is substantially exhibited.

An output amplifier 405 is an output buffer for outputting a signal output (409 SO) from the solid-state imaging device. As described above, the pixel cells 100 and the transistor cells 106 are driven by the row scan circuit and column scan circuit as the peripheral circuitry, the reset pulse, and the readout pulse, thereby allowing the pixel signal to be obtained.

As described above, a part of the pixel cells 100 is replaced with the transistor cells 106, thereby allowing the pixel signal to be obtained. In consideration of manufacturing variations, the photodiode 101 may be formed within each of the transistor cells 106. In addition, the transistor cells 106 may be provided with no floating diffusion 103. Furthermore, the floating diffusion 103 may be formed only within each of the transistor cells 106. Even in any of the above-mentioned cases, there are no differences in the operations, thus resulting in modification embodiments of the present embodiment.

### Second Embodiment

Next, a second embodiment will be described.

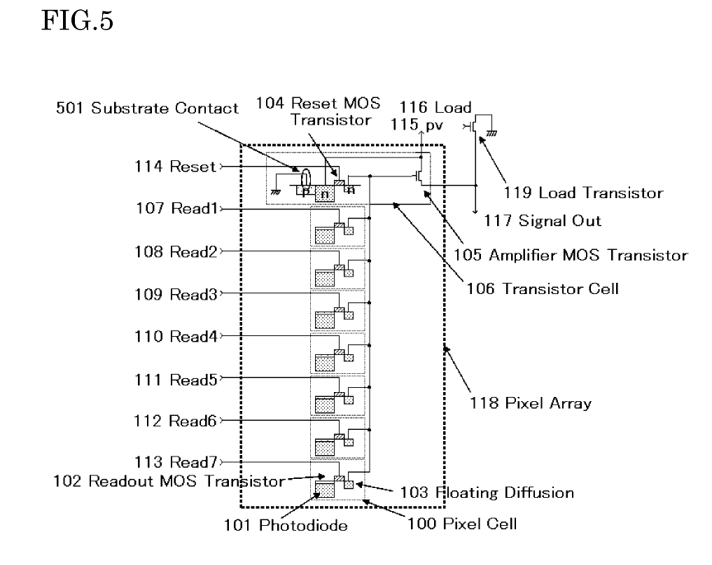

FIG. 5 shows features of a second embodiment and is a schematic diagram illustrating a circuit configuration of a pixel cell 100 and a sectional view thereof as well as a circuit configuration of a transistor cell 106 and a sectional view thereof.

In the present embodiment, a well contact 501 for newly forming a contact with a well is provided within each of the transistor cells 106 described in the first embodiment. Conventionally, it is required to arrange a well contact region within each of the pixel cells, thus causing a reduction in an area of the photodiode 101.

Moreover, a stress of the contact is exerted on a vicinity of the photodiode 101, thus leading to occurrence of a dark current. As a result, white dot noises occur, thus causing a remarkable reduction in image quality and a decrease in manufacturing yields.

Therefore, in the second embodiment, the well contact is formed in each of the transistor cells 106 region, which has no photodiode. This well contact suppresses the occurrence of the white dot noises, thereby improving the image quality. Furthermore, by arranging an appropriate number of the substrate contacts, low-frequency noises occurring in the silicon substrate can be improved.

### Third Embodiment

Next, a third embodiment will be described.

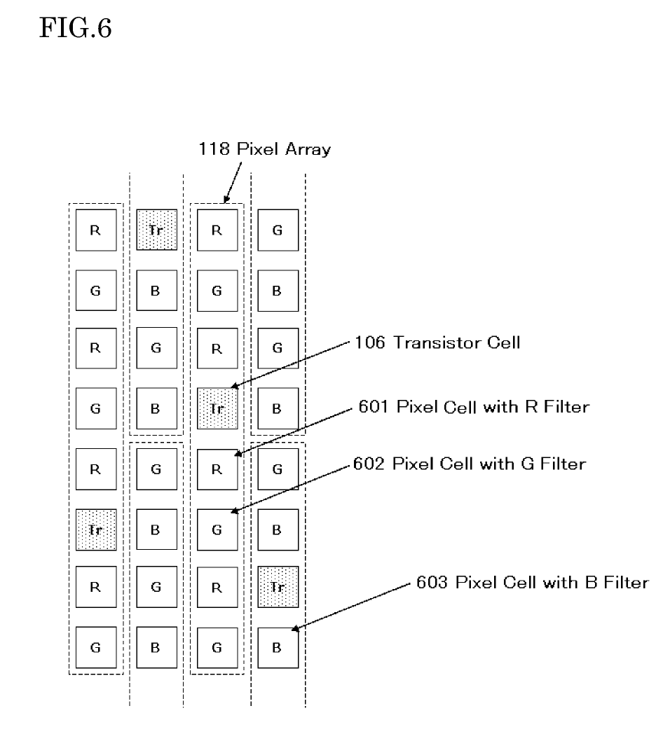

FIG. 6 is a diagram showing a layout of color filters of a solid-state imaging device of the third embodiment. In the solid-state imaging device, color filters are formed in pixel cells, thereby generating color signals of pixels.

Because in a transistor cell 106, a photoelectrically converted color signal cannot be read out, interpolation is performed by surrounding color pixel signals, thereby generating a color pixel signal. FIG. 6 is a schematic diagram illustrating the color filters upon the interpolation.

In the present embodiment, a plurality of pixel cells 100 and one transistor cell 106 are shared and as a result, one pixel array 118 is configured. On a periphery thereof, a pixel cell 601 having an R filter, a pixel cell 602 having a G filter, and a pixel cell 603 having a B filter are arranged. By utilizing a characteristic of a strong correlation of the color signals between neighboring pixels, a color signal is interpolated from surrounding pixels, thereby generating the color signal corresponding to the region of the transistor cell 106.

In the present embodiment, the transistor cells 106 are replaced with the color filter with the largest number arranged on the solid-state imaging device, thereby allowing fine color pixel signals to be generated. Note that in consideration of luminosity characteristics, it is preferable that in many cases of the solid-state imaging device, the transistor cells 106 are arranged in positions of G filters.

When the color signals of the transistor cells 106 are interpolated, based on the color pixel signals which have the same color and are in the vicinity of the region where the transistor cells 106 are arranged, the color signals may be interpolated. In this case, an effect that a detrimental influence such as false coloring hardly occurs can be attained.

In addition, in a case where it is desired to generate a frequency component of the color pixel signal in a wide frequency band, a color signal can be also interpolated from the neighboring pixel of the transistor cells 106. In such a case, since a central position of each of the color pixels is deviated, the interpolation is performed by multiplying the neighboring pixel signal by a constant weighting coefficient.

Furthermore, in a case where the interpolation of the color signals is performed, either of a technique of performing the interpolation by using an analog signal and a technique of performing the interpolation by using a digital signal can be employed. In a case where the interpolation is performed by using the analog signal, the interpolation is realized by sharing the wires of the amplifier MOS transistors arranged on the neighboring transistor cells.

On the other hand, in a case where the interpolation is performed by using the digital signal, conversion to a digital signal is performed by the ADC of the signal processing block and thereafter, processing of the interpolation can be performed through digital operation.

As described above, at readout timing of the transistor cells 106, the color pixel signal is generated based on information of the surrounding pixel signals. As a result, since the signal processing performed downstream of camera signal processing can be performed without changing the conventional signal processing method, an image can be obtained.

### Fourth Embodiment

Next, a fourth embodiment will be described.

According to the above-described embodiments, the transistor cells 106 are replaced with the pixel cells, whereby the transistor cells 106 are independently arranged in the region.

At this time, each MOS transistor is arranged in each of the transistor cells 106. Therefore, in the present embodiment, a configuration in which the transistor cells 106 are light-shielded by using metal wiring layers is adopted. This configuration allows occurrence of electrons excited by light to be suppressed, thereby enabling a fine image to be obtained.

### INDUSTRIAL APPLICABILITY

A solid-state imaging device of each of the above-described first, second, third, and fourth embodiments can be widely used in a camera or a camera system in which emphasis is placed on high image quality, for embodiment, in a digital still camera, a mobile telephone with a built-in camera, a camera for medical use, an on-vehicle camera, a video camera, a surveillance camera, system of a security camera, etc.

1-17. (canceled)

18. A solid-state imaging device, comprising:
a region (hereinafter, referred to as a pixel cell) in which at least a photodiode for performing photoelectric conversion, a readout MOS transistor for reading out from the photodiode an electric charge photoelectrically converted, and a floating diffusion for reading out and storing the electric charge via the readout MOS transistor from the photodiode are arranged; and
a region (hereinafter, referred to as a transistor cell) which includes an amplifier MOS transistor having a plurality of two or more said pixel cells connected thereto and a reset MOS transistor for resetting a potential of the floating diffusion so as to be a potential the same as a potential of a power source and in which at least the reset MOS transistor and the amplifier MOS transistors are arranged, wherein
the pixel cell and the transistor cell are two-dimensionally arranged,
a color signal on the transistor cell is generated by performing interpolation based on color signals of surrounding color filters, and
any of red (R), green (G), and blue (B) color filters are formed on the photodiode, and positions where the transistor cells are arranged are the same as positions, in each of which one of the color filters are arranged on the solid-state imaging device, with a number of the arranged color filters of the one of the color filters being largest.

19. A solid-state imaging device, comprising:
a pixel cell in which at least a photodiode for performing photoelectric conversion and a readout MOS transistor for reading out from the photodiode an electric charge photoelectrically converted;
a transistor cell in which at least an amplifier MOS transistor having a plurality of two or more said pixel cells connected thereto and a reset MOS transistor for resetting a potential of a floating diffusion so as to be a potential the same as a potential of a power source are arranged; and
the floating diffusion disposed so as to be connected to the pixel cell, the transistor cell, or both of the pixel cell and the transistor cell, wherein
the pixel cell and the transistor cell are two-dimensionally arranged,
a color signal on the transistor cell is generated by performing interpolation based on color signals of surrounding color filters, and
any of red (R), green (G), and blue (B) color filters are formed on the photodiode, and positions where the transistor cells are arranged are the same as positions, in each of which one of the color filters are arranged on the solid-state imaging device, with a number of the arranged color filters of the one of the color filters being largest.

20. The solid-state imaging device according to claim 18, wherein one said transistor cell is shared by the plurality of two or more said pixel cells.

21. The solid-state imaging device according to claim 18, wherein one said transistor cell is arranged so as to have an area the same as an area of one said pixel cell.

22. The solid-state imaging device according to claim 18, wherein the photodiode is formed in the transistor cell.

23. The solid-state imaging device according to claim 18, wherein the transistor cell is not formed in any of mutually neighboring upper, lower, right and left, and oblique positions.

24. The solid-state imaging device according to claim 18, wherein a contact for connecting, to GND, a P well formed below the photodiode is formed in a region of the transistor cell.

25. The solid-state imaging device according to claim 18, wherein after an ADC, formed on a substrate of silicon the same as silicon of which the solid-state imaging device is formed, has performed conversion to a digital signal, the interpolation of the color signal of the transistor cell is performed by a digital signal processor.

26. The solid-state imaging device according to claim 18, wherein the color signal in a pixel position of the transistor cell is generated by performing the interpolation based on the color signals of the surrounding color filters whose color is the same as a color of the color signal.

27. The solid-state imaging device according to claim 18, wherein the color signal corresponding to the color filter on the transistor cell is generated by performing the interpolation through multiplying, by a constant coefficient, the color signals of said pixel cells arranged on a periphery of the transistor cell.

28. The solid-state imaging device according to claim 18, wherein the transistor cell is light-shielded by a metal wiring layer.

29. A solid-state imaging device, comprising:
a region (hereinafter, referred to as a pixel cell) in which at least a photodiode for performing photoelectric conversion, a readout MOS transistor for reading out from the photodiode an electric charge photoelectrically converted, and a floating diffusion for reading out and storing the electric charge via the readout MOS transistor from the photodiode are arranged; and
a region (hereinafter, referred to as a transistor cell) which includes an amplifier MOS transistor having a plurality of two or more said pixel cells connected thereto and a reset MOS transistor for resetting a potential of the floating diffusion so as to be a potential the same as a potential of a power source and in which at least the reset MOS transistor and the amplifier MOS transistors are arranged, wherein
the pixel cell and the transistor cell are two-dimensionally arranged,
a color signal on the transistor cell is generated by performing interpolation based on color signals of surrounding color filters, and
any of cyan (Cy), green (G), yellow (Y), and magenta (Mg) color filters are formed on the photodiode, and positions where the transistor cells are arranged are the same as positions, in each of which one of the color filters are arranged on the solid-state imaging device, with a number of the arranged color filters of the one of the color filters being largest.

30. A solid-state imaging device, comprising:
a pixel cell in which at least a photodiode for performing photoelectric conversion and a readout MOS transistor for reading out from the photodiode an electric charge photoelectrically converted;
a transistor cell in which at least an amplifier MOS transistor having a plurality of two or more said pixel cells connected thereto and a reset MOS transistor for resetting a potential of a floating diffusion so as to be a potential the same as a potential of a power source are arranged; and
the floating diffusion disposed so as to be connected to the pixel cell, the transistor cell, or both of the pixel cell and the transistor cell, wherein
the pixel cell and the transistor cell are two-dimensionally arranged,
a color signal on the transistor cell is generated by performing interpolation based on color signals of surrounding color filters, and
any of cyan (Cy), green (G), yellow (Y), and magenta (Mg) color filters are formed on the photodiode, and positions where the transistor cells are arranged are the same as positions, in each of which one of the color filters are arranged on the solid-state imaging device, with a number of the arranged color filters of the one of the color filters being largest.

31. A solid-state imaging device, comprising:
a region (hereinafter, referred to as a pixel cell) in which at least a photodiode for performing photoelectric conversion, a readout MOS transistor for reading out from the photodiode an electric charge photoelectrically converted, and a floating diffusion for reading out and storing the electric charge via the readout MOS transistor from the photodiode are arranged; and
a region (hereinafter, referred to as a transistor cell) which includes an amplifier MOS transistor having a plurality of two or more said pixel cells connected thereto and a reset MOS transistor for resetting a potential of the floating diffusion so as to be a potential the same as a potential of a power source and in which at least the reset MOS transistor and the amplifier MOS transistors are arranged, wherein
the pixel cell and the transistor cell are two-dimensionally arranged,
a color signal on the transistor cell is generated by performing interpolation based on color signals of surrounding color fitters, and color filters other than the green (G) color filter are arranged on the transistor cell.

32. A solid-state imaging device, comprising:
a pixel cell in which at least a photodiode for performing photoelectric conversion and a readout MOS transistor for reading out from the photodiode an electric charge photoelectrically converted;
a transistor cell in which at least an amplifier MOS transistor having a plurality of two or more said pixel cells connected thereto and a reset MOS transistor for resetting a potential of a floating diffusion so as to be a potential the same as a potential of a power source are arranged; and
the floating diffusion disposed so as to be connected to the pixel cell, the transistor cell, or both of the pixel cell and the transistor cell, wherein
the pixel cell and the transistor cell are two-dimensionally arranged,
a color signal on the transistor cell is generated by performing interpolation based on color signals of surrounding color filters, and color filters other than the green (G) color filter are arranged on the transistor cell.
